(19) United States
(12) Patent Application Publication
(10) Pub. No.: US 2015/0326987 A1
(43) Pub. Date: Nov. 12, 2015

(54) PORTABLE BINAURAL RECORDING AND PLAYBACK ACCESSORY FOR A MULTIMEDIA DEVICE

(71) Applicant: Matthew Marrin, Canyon County, CA (US)

(72) Inventor: Matthew Marrin, Canyon County, CA (US)

(21) Appl. No.: 14/272,635

(22) Filed: May 8, 2014

(51) Int. Cl. H04S 7/00; H04R 5/033; H04S 1/00

(52) U.S. Cl. CPC H04S 7/30; H04S 1/00; H04R 5/033

(57) ABSTRACT

A portable binaural recording and playback accessory for a multimedia device includes headphones with embedded outside facing microphones, a protective mobile electronic device case with embedded stereo microphone preamplifier or audio video codec containing a microphone preamplifier, analog to digital converter/digital to analog converter (or digital signal processor), and a battery, allowing for the recording and playback of high quality binaural audio, while at the same time acting as a protective case and as an additional power supply.

### BACKGROUND

Smart phones and tablet computers have dominated consumer electronic sales in recent times, achieving a dominating presence in the lives of many. People now use their phones or tablet computers to read books, watch movies or television programs, listen to music, make telephone calls, record activities with portable, mountable camera/video recorders, and/or communicate via voice-over-IP with or without video data. Additionally, people are using smart phones and tablet computers for audio and video recording, from simply recording their own thoughts to recording conversations, business meetings, concerts, or education material such as presentations or podcasts. The accessibility and size of smart phones and tablet computers make them a quick and easy audio and video recording option. Unfortunately, recordings on phones will almost always be monophonic, reliant on the quality of the built-in microphone, creating a less than ideal audio recording.

### SUMMARY OF THE INVENTION

In accordance with the invention, headphones with embedded microphones connect to a protective mobile electronic device case which contains an audio/video codec and battery, allowing for the recording and playback of high quality binaural audio while at the same time acting as a protective case and as an additional power supply.

### BRIEF DESCRIPTION OF THE DRAWINGS

FIG. 1 is a perspective view of the binaural recording and playback accessory for a multimedia device of the present invention in use with a portable electronic device;

FIG. 2 is a perspective view of the headphones of the present invention;

FIG. 3 is an exploded view of the case and portable electronic device of the binaural recording and playback accessory for a multimedia device of the present invention;

FIG. 4A is a top view of the case of the binaural recording and playback accessory for a multimedia device of the present invention;

FIG. 4B is a right-side view of the case of the binaural recording and playback accessory for a multimedia device of the present invention;

FIG. 4C is a left-side case of the binaural recording and playback accessory for a multimedia device of the present invention;

FIG. 5 is a front view of the case of the binaural recording and playback accessory for a multimedia device of the present invention;

FIG. 6 is a rear view of the case of the binaural recording and playback accessory for a multimedia device of the present invention

FIG. 7 is a perspective view of the case of an alternate embodiment binaural recording and playback accessory for a multimedia device of the present invention;

FIG. 8 is a rear-perspective view of the case of an alternate embodiment binaural recording and playback accessory for a multimedia device of the present invention; and

FIG. 9 is a diagram illustrating the possible constituent parts of the audio/visual codec of the present invention.

### DETAILED DESCRIPTION

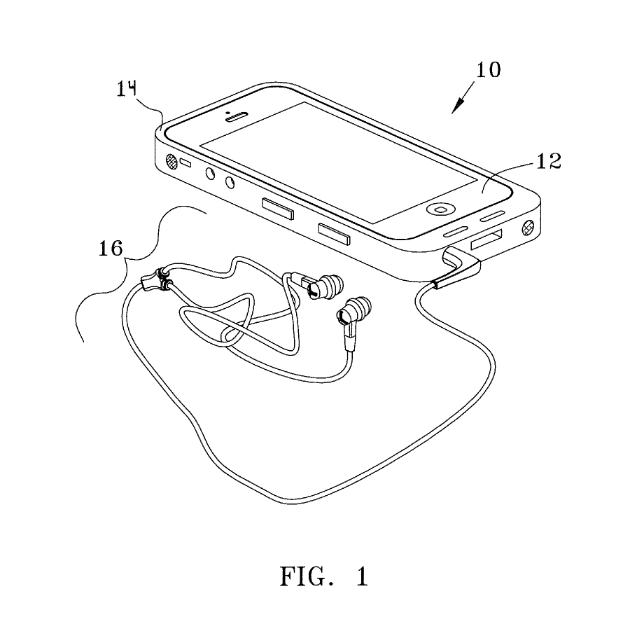

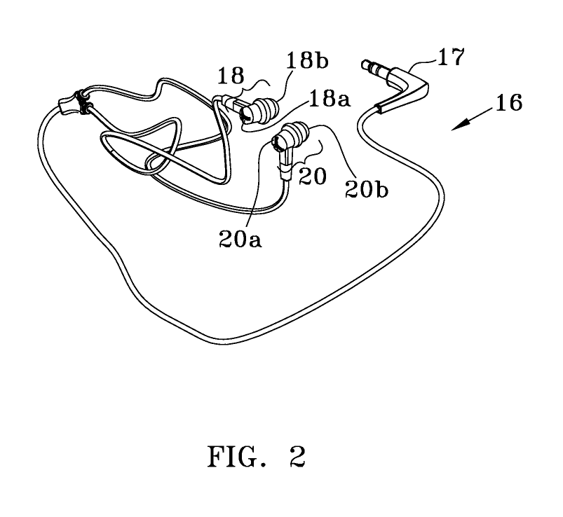

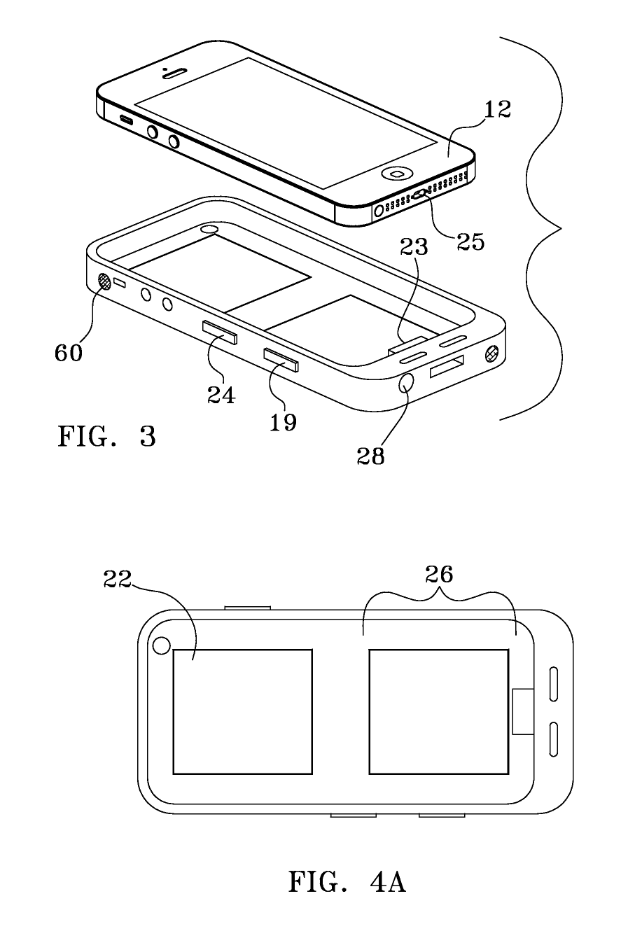

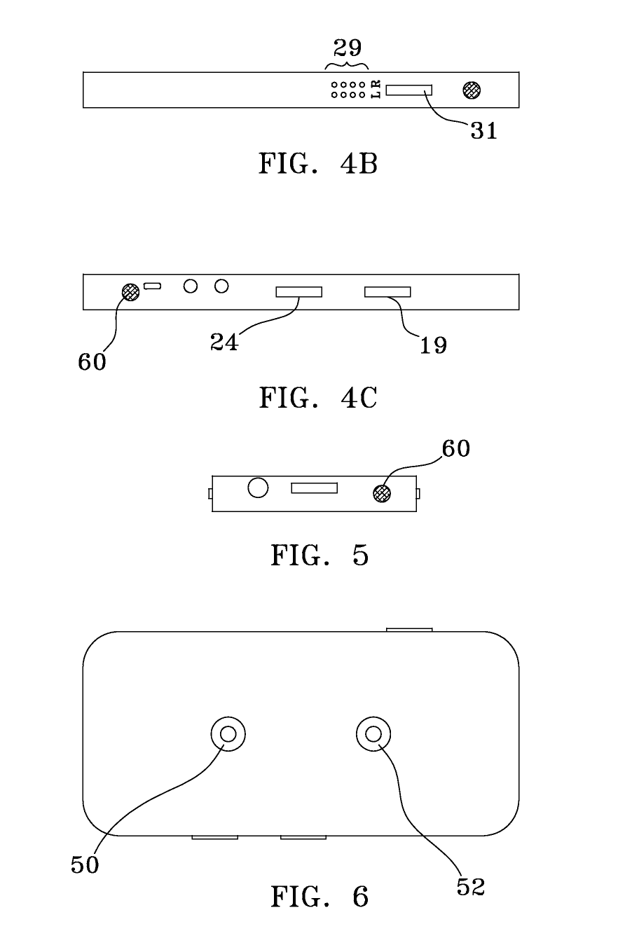

FIG. 1-2 illustrates the binaural recording and playback accessory for a multimedia device 10 of the present invention in use with a multimedia device 12. Accessory 10 comprises case 14 and headphones 16. The headphone assembly 16 comprises a right-ear piece 18, a right headphone speaker 18b, a right-ear piece microphone unit 18a, a left-ear piece 20, a left headphone speaker 20b, and a left-ear piece microphone unit 20a. As illustrated herein headphones 16 are earbud-style headphones; however, circumaural (around-the-ear) audio headphones that are either closed back or open backed could also be used without departing from the scope of the invention (in an openbacked design all ambient sound can still be “passed through” to the user concurrently with the audio playing through the speakers). Microphone units 18a and 20a are powered via what is known in the industry as “phantom power” (a minute electrical current passing to the microphone units through at least one of the same conductors that carry the microphone's right and left output signals.) The hard wiring of the headphones 16 in the preferred embodiment would utilize six conductors—three per side. This is possible by utilizing a common negative conductor for both the microphones (18a, 20a) and headphone speakers (18b, 20b).

In the preferred embodiment jack 17 is of a tip ring sleeve connector style, which is well known in the art. Jack 17 has two different regions (generally stepped in diameter) and an outer sleeve each connected to one of the three hardwires described above (not illustrated). Should an alternate embodiment have an additional microphone for capturing a user's talking (not illustrated) a seventh wire from this microphone would be required and the internal wiring for the connection to the jack 17 would be modified as would be well known in the industry. Microphones 18a, 20a are outward facing (face away from the head of the user) and lie along the centerline of the ear canal, when placed in a user's ear. Microphones 18a, 20a are non-directional, capturing sound from all directions, partially limited only by any physical barriers. Thus, microphones 18a, 20a are positioned to collect the exact same sound that would go into the ear canal as the ear canals would capture without headphones. In this way the sound origin, direction, volume, frequencies, tonal response, etc., as captured by microphones 18a, 20a will most closely approximate the sound collected by the users' ears at the time of a recording, essentially mimicking an Head Related Transfer Function (HRTF). When reproduced, this audio recording will closely mimic the original source (of the audio waves being captured) and coordinate this sound with any video captured from this point (that is the location of the multimedia device 12).

Microphones 18a, 20a are enabled via switch 19 which is mounted on case 14. A visual indicator 29 of the of the respective input and output levels from the microphones 18a, 20a, is also located on case 14 and may comprise a series of LEDs. Recording level control is accomplished via a two-way switch 31, allowing the user to raise or lower the recording level. The switch 31 will be mounted in the case adjacent the visual indicator 29. Since the separate microphones face 180 degrees apart and are blocked by the mass of a human head not all sounds recorded by the microphones will have the same volume. The lower of the two recorded signal volumes must be detected in order to be recorded. Additionally the higher of the two signals must be maintained below a maximum level for clarity. Switch 31 will allow both microphone sensitivities to be simultaneously adjusted upward or downward so as to insure a proper recording level is maintained as well as the stereo separation of the recorded signals. Although illustrated as wired, headphones 16, and hence microphones 18a, 20, could easily be enabled for wireless transmission such as Wi-Fi, Bluetooth, 4G including LTE, Wibro Evolution (3.9G), LTE-Advanced, or otherwise enabled for wireless transmission of audio signals.

Case 14 contains one or more batteries 22 which can be directed to serve as the primary power or reserve power for the multimedia device 12. In an alternate embodiment batteries 22 may also be directed to serve as the primary power source for the codec 26 and the headphones 16. Switch 24 allows the user to select the desired battery function. Case 14 can be water resistant or even completely waterproof.

Headphone jack input hole 28 is incorporated into case 14 and is adapted to receive headphone jack 17 and is matingly conformed for proper electrical connection with the various six (or seven) conductors of the aforementioned jack 17. Input hole 28 moves electronic signals both ways—by reception and transmission. Transmission in the cases of sound/music being played through the headphones 16 and the phantom power being sent to the microphone units 18a and 20a and reception when microphones 18a, 20a are recording. Case 14 connects to multimedia device 12 via a male multi-pin interface connector 23 that matingly conforms to a female multi-pin interface connector 25 incorporated into the multimedia device 12 and that allows electrical continuity between the multimedia device 12's electronic features, the codec 26, and the headphones 16. It should be noted that male multi-pin interface connector 23 could vary in positioning within case 14 and size, depending on “style” of the female multi-pin connector 25 of the multi-media device to which it connects. Additionally, headphones 16 could easily be replaced by using an adaptor (connected to case 14 via input hole 28) to connect two external microphones of any type.

There is a series of hard wires imbedded between the male multi-pin interface connector 23, the codec 26 and the headphones 16. It is to be noted that input hole 28 in case 14 is hard wired for electrical contact to both the codec 26 and the male multi-pin interface connector 23. This allows a plethora of different operations. It is to be noted that the headphone jack input hole of the multimedia device 12 is not utilized with assembly 10, rather it is replaced with the headphone jack input hole 28 which is wired to the codec 26 and the male multi-pin interface connector. If the multimedia device's headphone jack input hole was used, then there would be no way to route any of the microphones output to codec 26 for processing. In this way the input signal from the microphones 18a, 20a is processed first by codec 26 prior to being transmitted to device 12, while the output signal from device 12 passes through codec 26 prior to being transmitted to headphones 16.

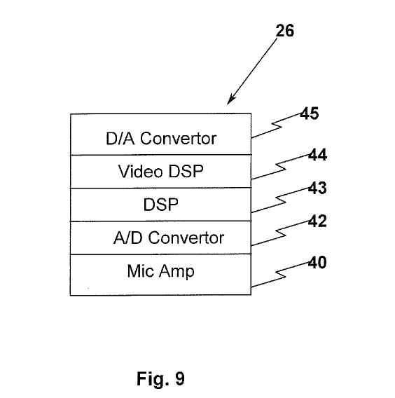

As used herein “codec” is hardware, firmware, software, or a combination of hardware, firmware, and software that provides the architecture, which is configurable into a number of functional arrangements to accomplish the audio and video processing necessary for accessory 10. As illustrated in FIG. 9, codec 26 may include microphone inputs, microphone amplifiers, analog to digital audio convertor, audio to digital signal processor, video digital processor, digital to analog audio convertor. However, in its most basic form codec 26 employs only a microphone preamp 40 to digital audio convertor 42.

Case 14 may include two embedded cameras 50, 52 adapted for stereoscopic video recording. In such an embodiment codec 26 would receive the two separate video signals from the cameras 50, 52 and process them appropriately for enhanced stereoscopic recording and playback via multimedia device 12. In this embodiment the initiation of a video recording by multimedia device 12 would not operate the local camera (that is the camera in device 12) but rather initiate operation and substitute the output of cameras 50, 52 into the multimedia device 12.

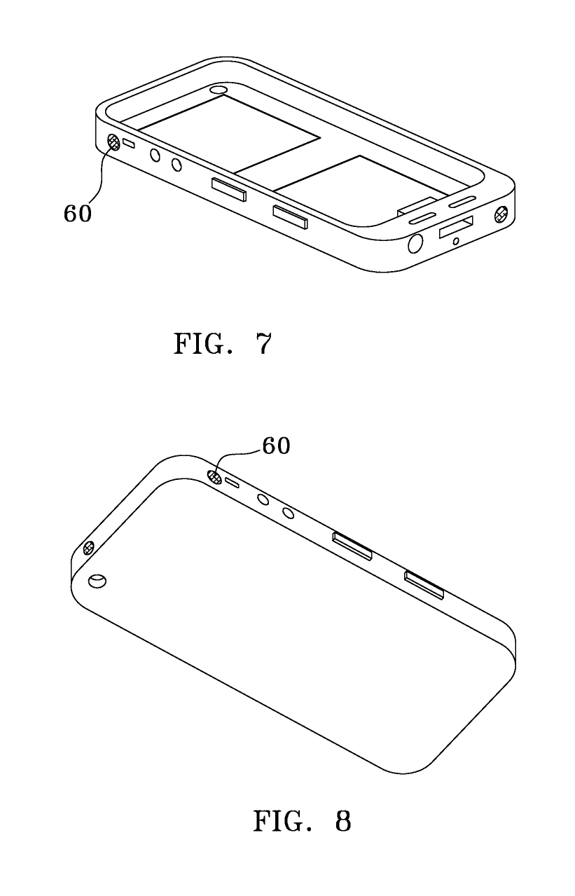

FIGS. 7 & 8 illustrate an alternate embodiment of case 14 wherein embedded microphones 60 into the sides and ends of case 14. This embodiment allows for headphone 16/microphones 18a, 18b to be omitted. The user would only require case 14 to produce high quality recordings, and no headphones or external microphones would be needed. Embedded microphones 60 could be located on opposing sides of case 14, at opposing ends of case 14, or on the back of case 14, and codec 26 could choose which pair of microphones 60 to employ for recording (or use both pairs) depending on the orientation of the phone. Additionally, digital signal processing could be added to individual microphones 60 to enhance the recording effect. The digital signal processing could include filtering, dynamic delay, mid side decode, variable phase inversion, compression, limiting, beam-forming,

HRTF filters, or any other digital signal processing technology. Microphones 60 are also visible in previous embodiments. It should be noted that microphones 60 can be embedded anywhere on case 14 without departing from the scope of the invention.

In operation, (playing headphones only) the digital audio output signal from the multimedia device 12 passes through the male and female pin connectors (23, 25) and is routed via hard wires to the codec's 26 digital/analog converter 44 where it is converted to an analog signal, and with no further processing required, routes the audio signals via the tip ring sleeve connector style jack 17 through input jack input hole 28, which then sends a positive and negative left and right signal to the headphones 16.

In a final embodiment codec 26 may amplify and process signals from both microphones 18a, 20a, bypass the analog/digital convertor and directly output their analog audio signal to speakers 18b, 20b in conjunction with audio signals from device 12 that it has converted from digital to analog and also simultaneously provided to the headphones 16. This feature is especially useful to individuals that are hearing impaired.

In operation (recording stereo sound only) when sound that is captured by microphones 18a, 20a the analog input signal travels via jack 17 through input hole 28 to codec 26 where preamp 40 amplifies the signal. Next analog/digital convertor converts the analog signal to digital and the now digital signal passes through the male connector 23 to female connector 25 into multimedia device 12 for recording. Codec 26 can optionally employ a digital signal processor 43 for additional processing.

In operation, (recording stereo sound synchronized with video recording) the multimedia device's video recording feature is deployed from the interface screen on the multimedia device which signals the internal camera to begin recording simultaneously with the initiation of a “record now” signal to the multimedia devices internal mono microphone. Since the microphones are electrically connected to the codec (pre amp, optional amp, digital signal processor and analog to digital converter) and the codec is connected to the multimedia device through the male and female pin connectors, the multimedia device's logic controller (internal microprocessor) recognizes the existence of a connected, alternate set of stereo microphones (the default as stereo always trumps mono in the hierarchy of recording) and restricts the use of the mono microphone. The “record now” signal is routed through the male and female multi pin interface connector through the codec to the microphones to begin recording. Phantom power is initiated to the microphones. The microphone's output signal passes through the tip ring sleeve connector style jack 17 and the headphone jack input hole 28 then via the hard wires to the codec where it sequentially passes through the pre amplifier, the digital signal processor and the digital/analog convertor. Eventually, after sound processing, a set of left and right digital audio signals are set via hard wires to the male and female multi pin interface connector and into the multimedia device's digital memory where it is stored in synchronization with the video images.

The forgoing description is meant to be exemplary only and should not be deemed limiting. Therefore, it is intended that this invention be limited only by the claims and the equivalents thereof.

I claim:

1. An accessory for binaural recording and playback for a multi-media device comprising:
headphones with a left and right speaker and left and right recording microphone;
a multi media protective case comprising an embedded battery and an audio codec, wherein said protective case is in electronic communication with a multi media device housed in said case;
and wherein said audio codec is in electrical communication with both said multi media device and said headphones.

2. The accessory for binaural recording and playback for a multi-media device of claim 1 wherein said battery provide power to said multimedia device or said codec by selection of a manual switch located on said case.

3. The accessory for binaural recording and playback for a multi-media device of claim 1 wherein said audio codec comprises a stereo microphone amplifier, an analog to digital convertor and a digital to analog convertor all in electronic communication for the processing of signals to-and-from said microphones and to-and-from said multimedia device.

4. The accessory for binaural recording and playback for a multi-media device of claim 3 wherein said codec further comprises a digital signal processor in electronic communication with said stereo microphone amplifier, said analog to digital convertor and said digital to analog convertor.

5. The accessory for binaural recording and playback for a multi-media device of claim 4 further comprising a left and right audio recording level indicator and sensitivity adjusting means all located on said case.

6. The accessory for binaural recording and playback for a multi-media device of claim 4 further comprising a set of cameras embedded in said case capable of stereoscopic recording.

7. The accessory for binaural recording and playback for a multi-media device of claim 3 wherein said codec further comprises a video digital signal processor in electronic communication with said stereo microphone amplifier, said analog to digital convertor and said digital to analog convertor.

8. The accessory for binaural recording and playback for a multi-media device of claim 4 wherein said codec further comprises a video digital signal processor in electronic communication with said stereo microphone amplifier, said analog to digital convertor and said digital to analog convertor.

9. The accessory for binaural recording and playback for a multi-media device of claim 8 further comprising a left and right audio recording level indicator and sensitivity adjusting means.

10. An accessory for binaural recording and playback for a multi-media device comprising:
a multi media protective case comprising at least two embedded microphones, an embedded battery, and an audio codec, wherein said protective case is in electronic communication with a multi media device housed in said case; and
wherein said audio codec is in electrical communication with both said multi media device and said headphones.
